(19) United States
(12) Patent Application Publication
(10) Pub. No.: US 2015/0277744 A1
(43) Pub. Date: Oct. 1, 2015

(54) Gesture Text Selection

(71) Applicant: Motorola Mobility LLC, Chicago, IL (US)

(72) Inventor: Honggang Tang, Beijing (CN)

(73) Assignee: Motorola Mobility LLC, Chicago, IL (US)

(21) Appl. No.: 14/227,101

(22) Filed: Mar. 27, 2014

(51) Int. Cl. G06F 3/0488

(52) U.S. Cl. CPC G06F 3/04883

(57) ABSTRACT

In embodiments of gesture text selection, an initial text selection start position is determined from a detected touch contact on a touch-sensitive interface. A first touch gesture input can be tracked on the touch-sensitive interface in a direction parallel to a text-line orientation to reposition the initial text selection start position to a repositioned text selection start position. A second touch gesture input can then be tracked on the touch-sensitive interface in a direction orthogonal to the text-line orientation, and the second touch gesture input is correlated to a selection of text beginning from the repositioned text selection start position and parallel to the text-line orientation.

### BACKGROUND

Computer devices, mobile phones, entertainment devices, navigation devices, and other electronic devices are increasingly designed with an integrated touch-sensitive interface, such as a touchpad or touch-screen display, that facilitates user-selectable touch and gesture inputs. For example, a user can input a touch gesture on a touch-sensitive interface of a device, such as with a finger or stylus, and initiate a horizontal gesture input that selects text in the form of a letter, a word, a line of text, a paragraph, or any grouping of letters, characters, words, text lines, and paragraphs. However, when using a finger on a touch-sensitive interface to select text, a user's finger typically blocks the view of the text that is being selected, making it difficult to both select a start position and to know where to stop the text selection.

### BRIEF DESCRIPTION OF THE DRAWINGS

Embodiments of gesture text selection are described with reference to the following Figures. The same numbers may be used throughout to reference like features and components that are shown in the Figures:

FIG. 1 illustrates an example system in which embodiments of gesture text selection can be implemented.

FIGS. 2-9 illustrate examples of gesture text selection in accordance with one or more embodiments.

FIG. 10 illustrates example method(s) of gesture text selection in accordance with one or more embodiments.

FIG. 11 illustrates various components of an example electronic device that can implement embodiments of gesture text selection.

### DETAILED DESCRIPTION

In embodiments of gesture text selection, an electronic device, such as a portable computer, gaming device, remote controller, navigation device, or mobile phone, can include a touch-sensitive interface via which a user can interact with the device and initiate touch gesture inputs and touch contact selections on a display of the device. For example, a user can initiate various text selection features based on the different functions and features of applications that are implemented by an electronic device. Text can be selected for copy and paste, to delete, format, move, and the like with various combinations of touch contacts and touch gesture inputs in word processing, database, and spreadsheet applications, as well as in email and other messaging applications, and when browsing websites.

In embodiments, a user can select a text selection start position on a touch-sensitive interface, and then initiate a first touch gesture input in a direction parallel to a text-line orientation of the text to reposition the text selection start position. The user can then initiate a second touch gesture input on the touch-sensitive interface in a direction orthogonal to the text-line orientation. The second touch gesture input is correlated to a selection of text beginning from the text selection start position and continuing parallel to the text-line orientation. This relationship between the direction of the second touch gesture input and the direction of the corresponding text selection may be counter-intuitive. However, the selected text in the horizontal, parallel direction is not blocked from view by a stylus or finger when the user initiates the second touch gesture input in the vertical, orthogonal direction. Additionally, embodiments of gesture text selection can be implemented for written languages other than the English language, such as for Chinese, Hebrew, or Arabic, where the other languages are written in different directions (other than written from left-to-right and then read from top-to-bottom as with standard English text).

While features and concepts of gesture text selection can be implemented in any number of different devices, systems, and/or configurations, embodiments of gesture text selection are described in the context of the following example devices, systems, and methods.

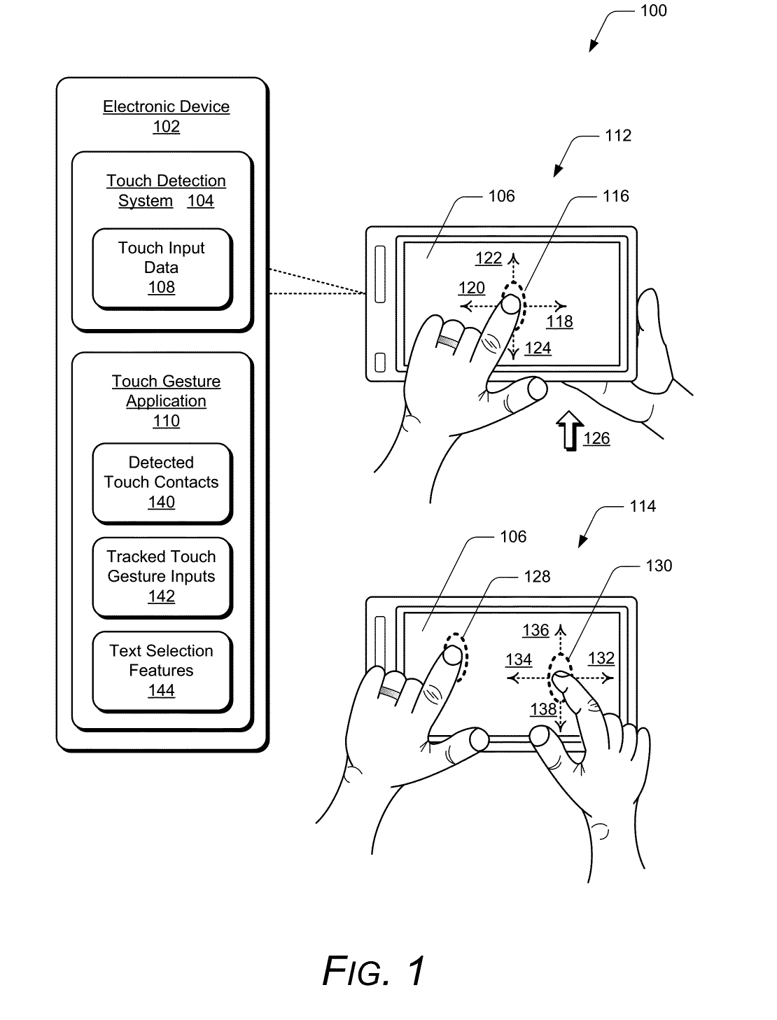

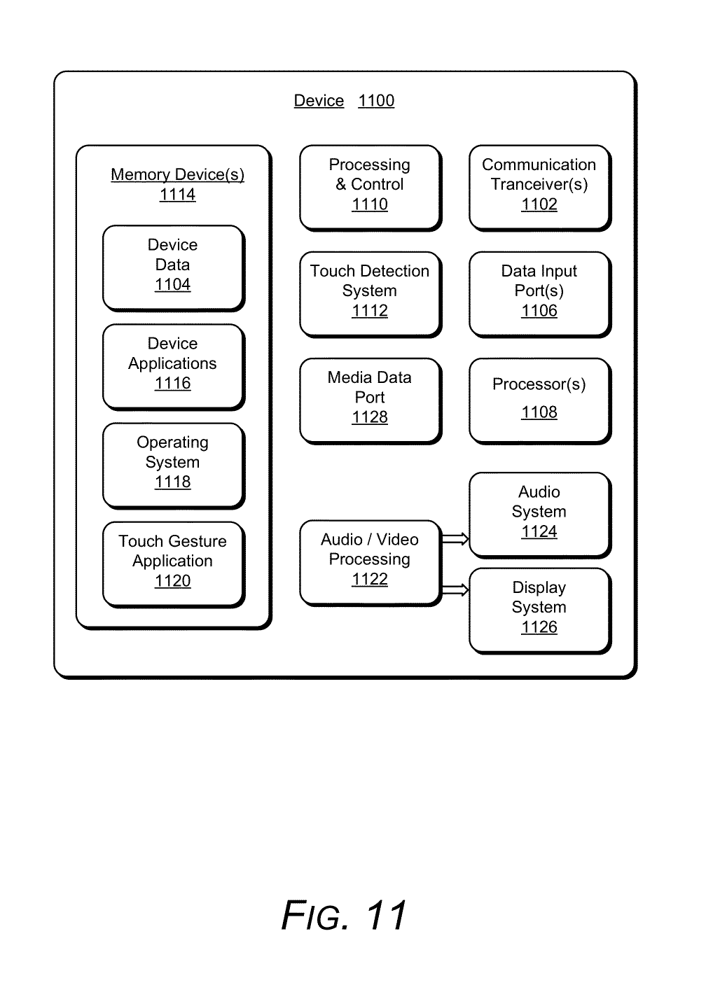

FIG. 1 illustrates an example system 100 in which embodiments of gesture text selection can be implemented. The example system 100 includes an electronic device 102, which may be any one or combination of a fixed or mobile device, in any form of a desktop computer, portable computer, tablet computer, mobile phone, media player, eBook, navigation device, gaming device, gaming controller, remote controller, digital camera, video camera, etc. The electronic device has a touch detection system 104 that includes a touch-sensitive interface 106, such as any type of integrated touchscreen display and/or touchpad on the front and/or back of the device. The touch-sensitive interface can be implemented as any type of a capacitive, resistive, or infrared interface to sense and/or detect gestures, inputs, and motions. Any of the electronic devices can be implemented with various components, such as one or more processors and memory devices, as well as any number and combination of differing components as further described with reference to the example electronic device shown in FIG. 11.

The touch detection system 104 is implemented to sense and/or detect user-initiated touch contacts and touch gesture inputs on the touch-sensitive interface, such as finger and/or stylus inputs. The touch detection system receives the touch contacts and touch gesture inputs as touch input data 108. In the example system 100, the electronic device 102 includes a touch gesture application 110 that can be implemented as computer-executable instructions, such as a software application, and executed by one or more processors to implement various embodiments of gesture text selection. In general, the touch gesture application is implemented to detect touch contacts on the touch-sensitive interface 106 based on the received touch input data 108. The touch gesture application is also implemented to detect and track touch gesture inputs on the touch-sensitive interface based on the touch input data 108 that is received as a touch gesture input, or as a combination of inputs.

An example of one-finger (or stylus) gesture text selection is shown at 112, where a user might hold the electronic device 102 with one hand, and interact with the touch-sensitive interface 106 with a finger of the other hand. An example of multi-finger gesture text selection is shown at 114, where the user might interact with the touch-sensitive interface of the device with more than one finger when the device is supported on a table or desk, or in a device dock.

In the first example at 112, the user can initiate a touch contact 116 and continue with a touch gesture input in any direction starting from the touch contact. For example, the user may initiate a touch gesture input to the right 118, left 120, up 122, or down 124 (or a combination of these and/or other directions). The gesture input directions are labeled right, left, up, and down merely for discussion relative to an orientation 126 of the electronic device as illustrated, and any of the directions described herein are approximate. In practice, the approximate direction of a touch gesture input may be identified by any frame of reference, such as based on device orientation, content that may be displayed on an integrated display, or based on the orientation of the displayed content.

The second example of two-finger gesture text selection is shown at 114, where the user can initiate a first touch contact 128 with a first finger on the touch-sensitive interface 106 of the device. The user can then initiate a second touch contact 130 with a second finger at a different position on the touch-sensitive interface, and continue with a touch gesture input in any direction starting from the second touch contact. For example, the user may initiate a touch gesture input to the right 132, left 134, up 136, or down 138 (or a combination of these and/or other directions). Again, the gesture input directions are labeled right, left, up, and down merely for discussion relative to an orientation of the electronic device as illustrated.

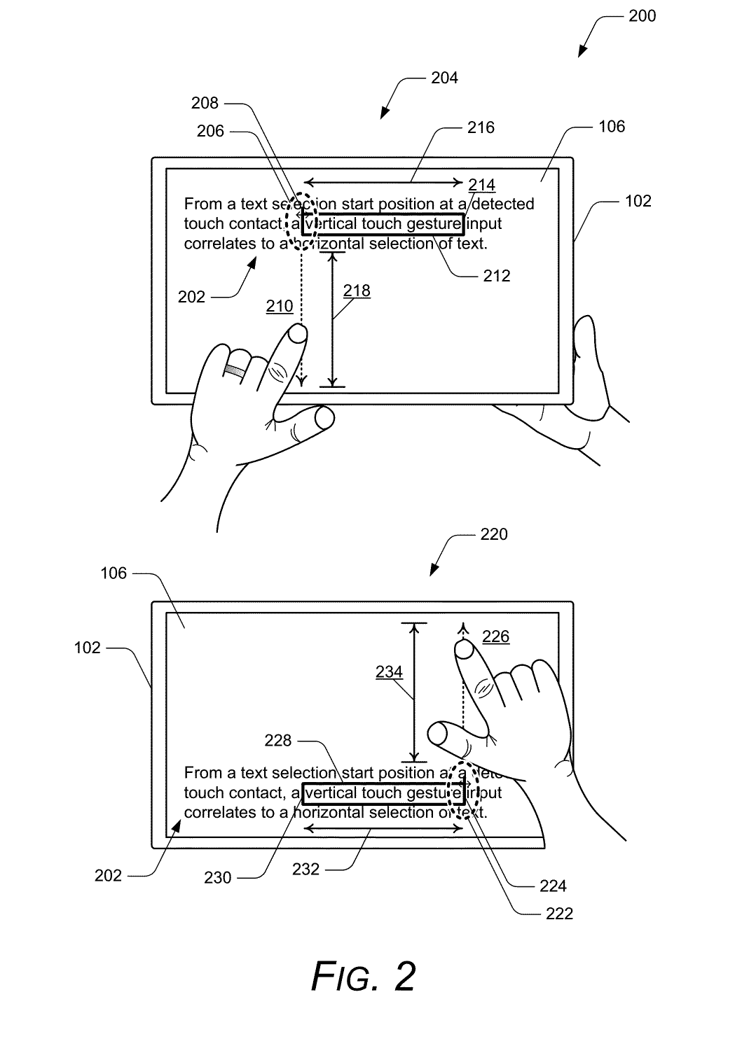

The touch gesture application 110 is implemented to determine the touch contact 116, or the combination of touch contacts 128 and 130, from the touch input data 108 as the detected touch contacts 140. The touch gesture application is also implemented to determine any of the various touch gesture inputs, or combination of gesture inputs, as the tracked touch gesture inputs 142 from the touch input data 108. Additionally, the touch gesture application is implemented to initiate text selection features 144 in embodiments of gesture text selection based on the various combinations of detected touch contacts and tracked touch gesture inputs as described with reference to FIGS. 2-9. The various text selection features may also be implemented based on the different functions and features of other applications that are implemented by the electronic device. For example, text can be selected for copy and paste, to delete, format, move, and the like with various combinations of detected touch contacts and tracked touch gesture inputs in word processing, database, and spreadsheet applications, as well as in email and other messaging applications, and when browsing websites.

FIG. 2 illustrates examples 200 of one-finger (or stylus) gesture text selection, such as implemented with the electronic device 102 and the various components described with reference to FIG. 1. The electronic device 102 includes the touch-sensitive interface 106 as part of an integrated display on which text 202 is displayed. As shown at 204, a user can initiate a touch contact 206 on the touch-sensitive interface of the device, and the touch gesture application 110 can determine a text selection start position 208 from the detected touch contact. The user can initiate a touch gesture input 210 on the touch-sensitive interface starting from the touch contact. The touch gesture application can track the touch gesture input as a continuation of the detected touch contact at the text selection start position.

In this example, the direction of the touch gesture input moves down relative to the orientation of the device. The direction of the touch gesture input is also orthogonal to a text-line orientation, which is horizontal text in this example, and the touch gesture input traverses across lines of the text relative to the text-line orientation. Although only three lines of text are shown in the several examples described herein, multiple lines of text may fill the display, such as when a word processing document or email is displayed, and the touch gesture inputs traverse across the multiple lines of the text.

In an embodiment, the touch gesture application 110 is implemented to correlate the touch gesture input 210 to a selection of text 212 in a direction parallel to the text-line orientation beginning from the text selection start position 208 to a text selection end position 214. Although the relationship between the direction of the touch gesture input and the direction of the text selection may be counter-intuitive, the selected text in the horizontal, parallel direction is not blocked from view by a stylus or finger when the user initiates the touch gesture input in the vertical, orthogonal direction. In this example, the selection of the text is less than an entire line of the text and proportional to a distance of the touch gesture input. For example, a length or parallel distance 216 of the text selection is proportional to the orthogonal distance 218 of the touch gesture input, where the text selection can be based on a ratio of the parallel distance to the orthogonal distance. In the implementations described herein, the ratio can be implemented as any proportion between the two distances (e.g., 1:1, 5:1, etc.), may be based on a size of the display or the device, and optionally, can be a user-configurable feature.

In the example shown at 220, a user can initiate a touch contact 222 on the touch-sensitive interface of the device, and the touch gesture application 110 can determine a text selection start position 224 from the detected touch contact. The user can also initiate a touch gesture input 226 on the touch-sensitive interface starting from the touch contact, and the touch gesture application can track the touch gesture input as a continuation of the detected touch contact at the text selection start position. In this example, the direction of the touch gesture input moves up relative to the orientation of the device. The direction of the touch gesture input is also orthogonal to the text-line orientation, and the touch gesture input traverses across lines of the text relative to the text-line orientation.

In an embodiment, the touch gesture application 110 is implemented to correlate the touch gesture input 226 to a selection of text 228 in a direction parallel to the text-line orientation beginning from the text selection start position 224 to a text selection end position 230. In this example, the text selection is less than an entire line of the text and proportional to a distance of the touch gesture input. For example, a length or parallel distance 232 of the text selection is proportional to the orthogonal distance 234 of the touch gesture input, where the text selection can be based on a ratio of the parallel distance to the orthogonal distance.

In the example shown at 204, the selection of text 212 is a section along the line of the text after the text selection start position 208 (i.e., to the right of the text selection start position), and the text selection is based on the touch gesture input 210 traversing down across the lines of the text in the direction orthogonal to the text-line orientation. Alternatively, in the example shown at 220, the selection of text 228 is a section along the line of the text before the text selection start position 224 (i.e., to the left of the text selection start position), and the text selection is based on the touch gesture input 226 traversing up across the lines of the text in the direction orthogonal to the text-line orientation.

Thus, based on the direction of a tracked touch gesture input, the direction of text selection starting from the text selection start position may differ. As shown in the examples 200, if the touch gesture input travels in the inter-line reading direction (e.g., down for English text), text selection will travel in the intra-line reading direction (e.g., from left-to-right for English text) starting from the text selection start position. Alternatively, if the touch gesture input travels against the inter-line reading direction (e.g., up for English text), text selection will travel against the intra-line reading direction (e.g., from right-to-left for English text) starting from the text selection start position.

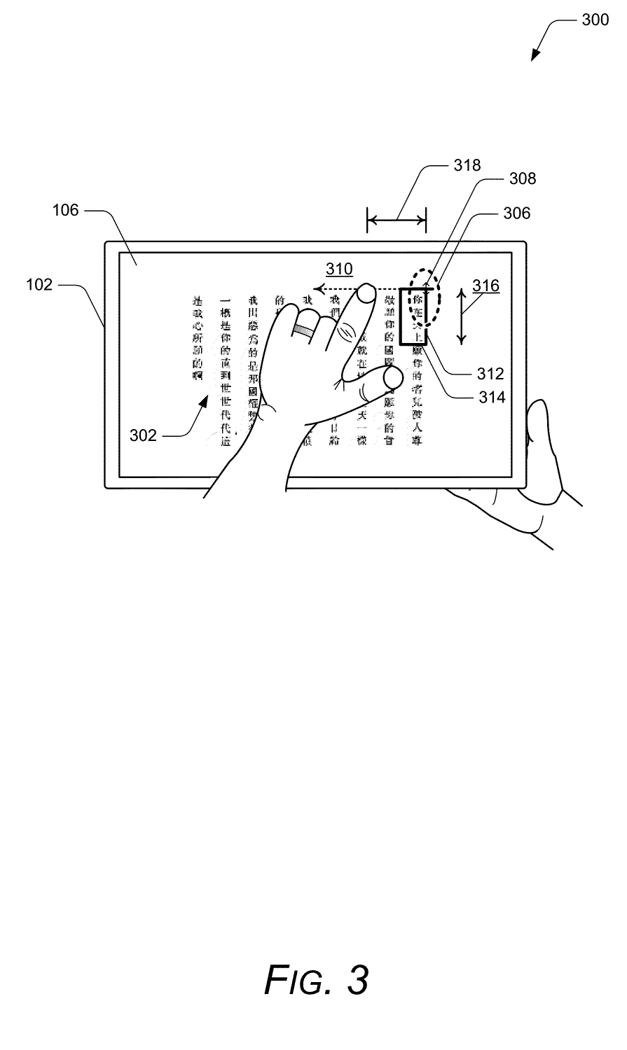

FIG. 3 illustrates an example 300 of one-finger (or stylus) gesture text selection implemented for traditional Chinese written language. The various embodiments of gesture text selection described herein can be implemented for written languages other than the English language, such as for Chinese, Hebrew, and Arabic, where the other languages are written in different directions other than from left-to-right and then from top-to-bottom as with standard English text. For example, traditional Chinese is often written in columns from the top down with the columns being read from right-to-left, whereas Hebrew and Arabic are written from right-to-left with the rows of text being read from top-to-bottom. The example 300 can be implemented with the electronic device 102 and the various components described with reference to FIG. 1. The electronic device 102 includes the touch-sensitive interface 106 as part of an integrated display on which text 302 is displayed.

A user can initiate a touch contact 306 on the touch-sensitive interface of the device, and the touch gesture application 110 can determine a text selection start position 308 from the detected touch contact. The user can then initiate a touch gesture input 310 on the touch-sensitive interface starting from the touch contact. The touch gesture application can track the touch gesture input as a continuation of the detected touch contact at the text selection start position. In this example, the direction of the touch gesture input moves left relative to the orientation of the device. The direction of the touch gesture input is also orthogonal to a text-line orientation of the text, which is vertical in this example, and the touch gesture input traverses across lines of the text and orthogonal to the text-line orientation.

In an embodiment, the touch gesture application 110 is implemented to correlate the touch gesture input 310 to a selection of text 312 in a direction parallel to the text-line orientation beginning from the text selection start position 308 to a text selection end position 314. The text selection of the first four Chinese characters translates to “you are [in the] heavens” in English. Note that the selected text in the vertical direction is not blocked from view by a stylus or finger when the user initiates the touch gesture input in the horizontal direction. In this example, a length or distance 316 of the text selection is proportional to the gesture distance 318 of the touch gesture input, where the text selection can be based on a ratio of the text selection distance to the gesture distance.

In the example, the selection of text 312 is a section of characters after the text selection start position 308 (i.e., below the text selection start position because intra-line Chinese reads from top-to-bottom), and the text selection is based on the touch gesture input 310 traversing left across the columns of the text in the direction orthogonal to the text-line orientation. Alternatively, a selection of text can be a section of characters before the text selection start position 308 (i.e., above the text selection start position), and the text selection can be based on a second touch gesture input traversing right across the columns of the text in the direction orthogonal to the text-line orientation. Thus, despite significant differences in text-line orientation (e.g., English text-lines running from left-to-right and Chinese text-lines running from top-to-bottom), and inter-line reading direction (e.g., English inter-line reading from top-to-bottom and Chinese inter-line reading from right-to-left), embodiments of gesture text selection can support text selection without a finger or stylus blocking the text selection view.

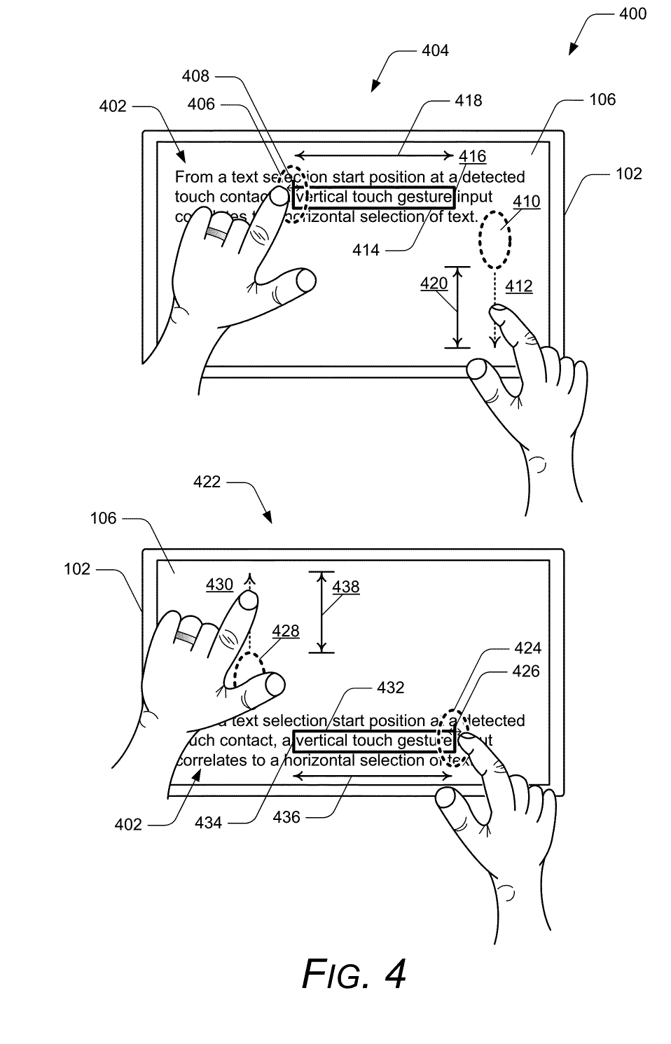

FIG. 4 illustrates examples 400 of two-finger gesture text selection, such as implemented with the electronic device 102 and the various components described with reference to FIG. 1. The electronic device 102 includes the touch-sensitive interface 106 as part of an integrated display on which text 402 is displayed. As shown at 404, a user can initiate a touch contact 406 with a first finger on the touch-sensitive interface of the device, and the touch gesture application 110 can determine a text selection start position 408 from the detected touch contact. The user can then initiate an additional touch contact 410 with a second finger at a different position on the touch-sensitive interface, and continue with a touch gesture input 412 starting from the additional touch contact. The touch gesture application can track the touch gesture input as a continuation of the detected additional touch contact 410. In this example, the direction of the touch gesture input moves down relative to the orientation of the device. The direction of the touch gesture input is also orthogonal to a text-line orientation, which is horizontal text in this example, and the touch gesture input traverses across lines of the text relative to the text-line orientation.

In an embodiment, the touch gesture application 110 is implemented to correlate the touch gesture input 412 to a selection of text 414 in a direction parallel to the text-line orientation beginning from the text selection start position 408 to a text selection end position 416. In this example, the selection of the text is less than an entire line of the text and proportional to a distance of the touch gesture input. For example, a length or parallel distance 418 of the text selection is proportional to the orthogonal distance 420 of the touch gesture input, where the text selection can be based on a ratio of the parallel distance to the orthogonal distance.

In the example shown at 422, a user can initiate a touch contact 424 on the touch-sensitive interface of the device, and the touch gesture application 110 can determine a text selection start position 426 from the detected touch contact. The user can then initiate an additional touch contact 428 with a second finger at a different position on the touch-sensitive interface, and continue with a touch gesture input 430 starting from the additional touch contact. The touch gesture application can track the touch gesture input as a continuation of the detected additional touch contact 428. In this example, the direction of the touch gesture input moves up relative to the orientation of the device. The direction of the touch gesture input is also orthogonal to the text-line orientation, which is horizontal text in this example, and the touch gesture input traverses across lines of the text relative to the text-line orientation.

In an embodiment, the touch gesture application 110 is implemented to correlate the touch gesture input 430 to a selection of text 432 in a direction parallel to the text-line orientation beginning from the text selection start position 426 to a text selection end position 434. In this example, the text selection is less than an entire line of the text and proportional to a distance of the touch gesture input. For example, a length or parallel distance 436 of the text selection is proportional to the orthogonal distance 438 of the touch gesture input, where the text selection can be based on a ratio of the parallel distance to the orthogonal distance.

In the example shown at 404, the selection of text 414 is a section along the line of the text after the text selection start position 408 (i.e., to the right of the text selection start position), and the text selection is based on the touch gesture input 412 traversing down across the lines of the text in the direction orthogonal to the text-line orientation. Alternatively, in the example shown at 422, the selection of text 432 is a section along the line of the text before the text selection start position 426 (i.e., to the left of the text selection start position), and the text selection is based on the touch gesture input 430 traversing up across the lines of the text in the direction orthogonal to the text-line orientation.

A benefit of this variant of two-finger gesture text selection shown in the examples 400 is that the touch-sensitive interface 106 can detect a placement of the second finger while the first finger is still in contact with the touch-sensitive interface. Then, the first finger can be removed from the touch-sensitive interface and the text selection start position can be visually verified without the first finger blocking the text selection view.

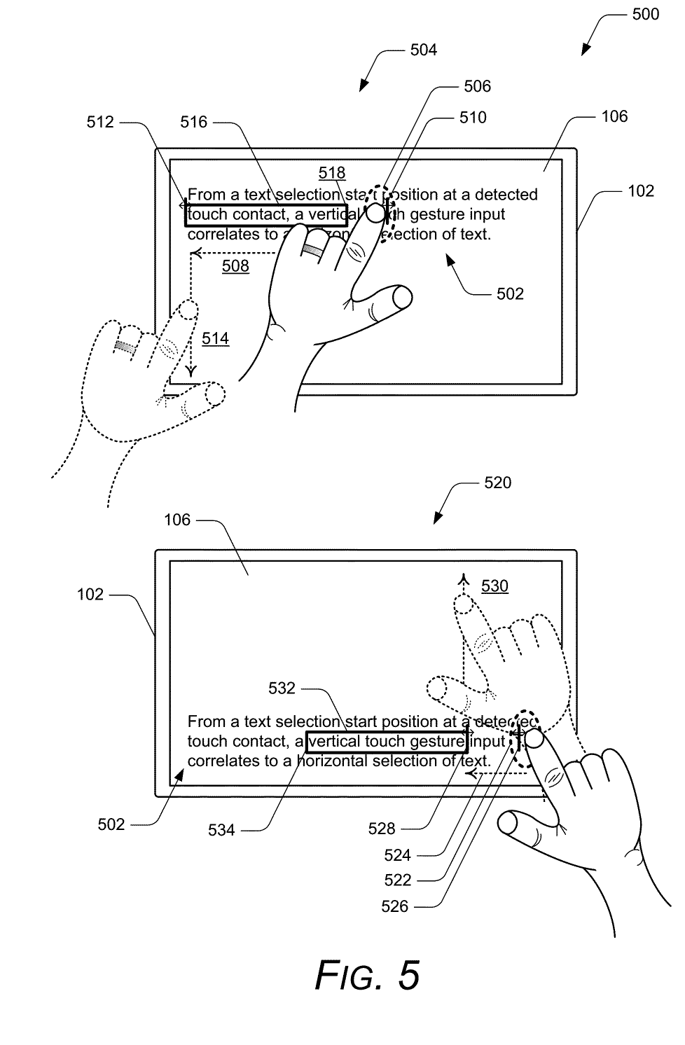

In the previous examples of FIGS. 2-4, it has been assumed that the first touch contact 206, 222, 306, 406, 424 was accurately placed on the touch-sensitive interface 106 such that the touch gesture application resolved the touch input data to a detected touch contact and respective text selection start position 208, 224, 308, 408, 426 that coincided with the user's desired text selection start position. This, however, is not always the case due to different finger contact surfaces, different touch-screen calibrations, or simply misplacement of the finger by the user. The following examples described in FIGS. 5-8 address repositioning the text selection start position to coincide with the user's desired text selection start position if the initially-determined text selection start position does not coincide with the user's intent.

FIG. 5 illustrates examples 500 of one-finger (or stylus) gesture text selection, such as implemented with the electronic device 102 and the various components described with reference to FIG. 1. The electronic device 102 includes the touch-sensitive interface 106 as part of an integrated display on which text 502 is displayed. As shown at 504, a user can initiate a touch contact 506 on the touch-sensitive interface of the device, and then initiate a first touch gesture input 508 continuing from the touch contact. The touch gesture application 110 can track the first touch gesture input as a continuation of the detected touch contact. In this example, the direction of the first touch gesture input moves left and is horizontal relative to the orientation of the device. The direction of the first touch gesture input 508 is also in a direction parallel to the text-line orientation, which is horizontal text in this example.

In an embodiment, the touch gesture application 110 is implemented to determine an initial text selection start position 510 from the detected touch contact 506. The touch gesture application can then establish a repositioned text selection start position 512 based on the first touch gesture input 508 that is continued from the touch contact in the direction left and parallel to the text-line orientation. When the repositioned text selection start portion coincides with the user's intent, the user can then initiate a second touch gesture input 514 on the touch-sensitive interface in a direction orthogonal to the text-line orientation.

The touch gesture application 110 can track the second touch gesture input 514 from the end of the first touch gesture input 508. In this example, the direction of the second touch gesture input moves down relative to the orientation of the device. The direction of the second touch gesture input is also orthogonal to the text-line orientation of the text, and the second touch gesture input traverses across lines of the text relative to the text-line orientation. In an embodiment, the touch gesture application 110 is implemented to correlate the second touch gesture input 514 to a selection of text 516 in a direction parallel to the text-line orientation beginning from the repositioned text selection start position 512 and selecting to the right to a text selection end position 518. In this example, the selection of the text is less than an entire line of the text and proportional to a distance of the second touch gesture input 514, such as previously described with respect to FIG. 2.

In the example shown at 520, a user can initiate a touch contact 522 on the touch-sensitive interface of the device, and then initiate a first touch gesture input 524 continuing from the touch contact. In this example, the direction of the first touch gesture input moves left and is horizontal relative to the orientation of the device, which is also in a direction parallel to the text-line orientation of the text. The touch gesture application 110 can track the first touch gesture input as a continuation of the detected touch contact. In an embodiment, the touch gesture application is implemented to determine an initial text selection start position 526 from the detected touch contact 522. The touch gesture application can then establish a repositioned text selection start position 528 based on the first touch gesture input 524 that is continued from the touch contact in the direction parallel to the text-line orientation.

The user can then initiate a second touch gesture input 530 on the touch-sensitive interface in a direction orthogonal to the text-line orientation. The touch gesture application 110 can track the second touch gesture input from the end of the first touch gesture input 524. In this example, the direction of the second touch gesture input moves up relative to the orientation of the device. The direction of the second touch gesture input is also orthogonal to the text-line orientation of the text, and the second touch gesture input traverses across lines of the text relative to the text-line orientation. In an embodiment, the touch gesture application 110 is implemented to correlate the second touch gesture input 530 to a selection of text 532 in a direction parallel to the text-line orientation beginning from the repositioned text selection start position 528 and selecting to the left to a text selection end position 534. In this example, the selection of the text is less than an entire line of the text and proportional to a distance of the second touch gesture input 530, such as previously described with respect to FIG. 2.

In the example shown at 504, the selection of text 516 is a section along the line of the text after the repositioned text selection start position 512 (i.e., to the right of the repositioned text selection start position), and the text selection is based on the second touch gesture input 514 traversing down across the lines of the text in a direction orthogonal to the text-line orientation. Alternatively, in the example shown at 520, the selection of text 532 is a section along the line of the text before the repositioned text selection start position 528 (i.e., to the left of the repositioned text selection start position), and the text selection is based on the second touch gesture input 530 traversing up across the lines of the text in the direction orthogonal to the text-line orientation.

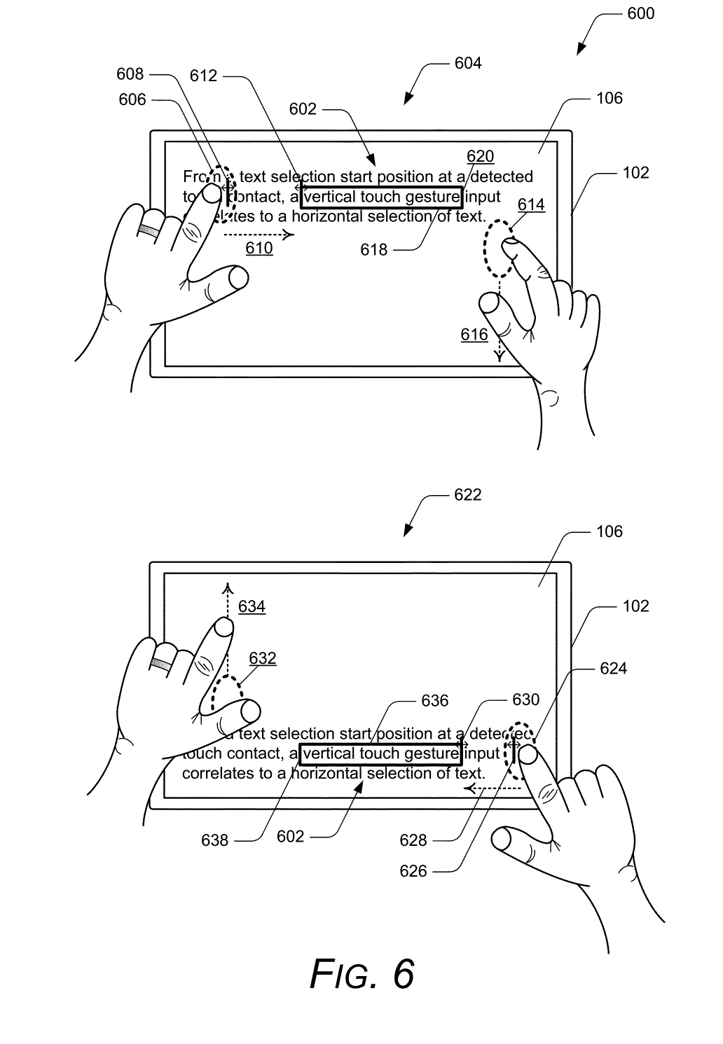

FIG. 6 illustrates examples 600 of a two-finger gesture text selection, such as implemented with the electronic device 102 and the various components described with reference to FIG. 1. The electronic device 102 includes the touch-sensitive interface 106 as part of an integrated display on which text 602 is displayed. As shown at 604, a user can initiate a touch contact 606 with a first finger on the touch-sensitive interface of the device, and the touch gesture application 110 is implemented to determine an initial text selection start position 608 from the detected touch contact. The user can then initiate a first touch gesture input 610 continuing from the touch contact to establish a repositioned text selection start position 612. The direction of the first touch gesture input moves right and is horizontal relative to the orientation of the device. The direction of the first touch gesture input is also in a direction parallel to the text-line orientation, which is horizontal text in this example. The touch gesture application 110 can track the first touch gesture input 610 as a continuation of the detected touch contact, and establish the repositioned text selection start position 612 based on the first touch gesture input 610 that is continued from the touch contact in the direction parallel to the text-line orientation.

The user can then initiate an additional touch contact 614 with a second finger at a different position on the touch-sensitive interface, and continue with a second touch gesture input 616 starting from the additional touch contact. The touch gesture application 110 can track the second touch gesture input as a continuation of the detected additional touch contact 614. In this example, the direction of the second touch gesture input 616 moves down relative to the orientation of the device. The direction of the second touch gesture input is also orthogonal to a text-line orientation, which is horizontal text in this example, and the second touch gesture input traverses across lines of the text relative to the text-line orientation. In an embodiment, the touch gesture application 110 is implemented to correlate the second touch gesture input 616 to a selection of text 618 in a direction parallel to the text-line orientation beginning from the repositioned text selection start position 612 to a text selection end position 620. In this example, the selection of the text is less than an entire line of the text and proportional to a distance of the second touch gesture input 616, such as previously described with respect to FIG. 2.

In the example shown at 622, a user can initiate a touch contact 624 with a first finger on the touch-sensitive interface of the device to establish a position of an initial text selection start position 626. The user can then initiate a first touch gesture input 628 continuing from the touch contact to establish a repositioned text selection start position 630. The direction of the first touch gesture input moves left and is horizontal relative to the orientation of the device. The direction of the first touch gesture input is also in the direction parallel to the text-line orientation. The touch gesture application 110 can track the first touch gesture input 628 as a continuation of the detected touch contact, and establish the repositioned text selection start position 630 based on the first touch gesture input continued from the touch contact in the direction parallel to the text-line orientation.

The user can then initiate an additional touch contact 632 with a second finger at a different position on the touch-sensitive interface, and continue with a second touch gesture input 634 starting from the additional touch contact. The touch gesture application 110 can track the second touch gesture input as a continuation of the detected additional touch contact 632. In this example, the direction of the second touch gesture input 634 moves up relative to the orientation of the device. The direction of the second touch gesture input is also orthogonal to the text-line orientation of the text, and the second touch gesture input traverses across lines of the text relative to the text-line orientation. In an embodiment, the touch gesture application 110 is implemented to correlate the second touch gesture input 634 to a selection of text 636 in a direction parallel to the text-line orientation beginning from the repositioned text selection start position 630 to a text selection end position 638. In this example, the selection of the text is less than an entire line of the text and proportional to a distance of the second touch gesture input 634, such as previously described with respect to FIG. 2.

In the example shown at 604, the selection of text 618 is a section along the line of the text after the repositioned text selection start position 612 (i.e., to the right of the repositioned text selection start position), and the text selection is based on the second touch gesture input 616 traversing down across the lines of the text in the direction orthogonal to the text-line orientation. Alternatively, in the example shown at 622, the selection of text 636 is a section along the line of the text before the repositioned text selection start position 630 (i.e., to the left of the repositioned text selection start position), and the text selection is based on the second touch gesture input 634 traversing up across the lines of the text in the direction orthogonal to the text-line orientation.

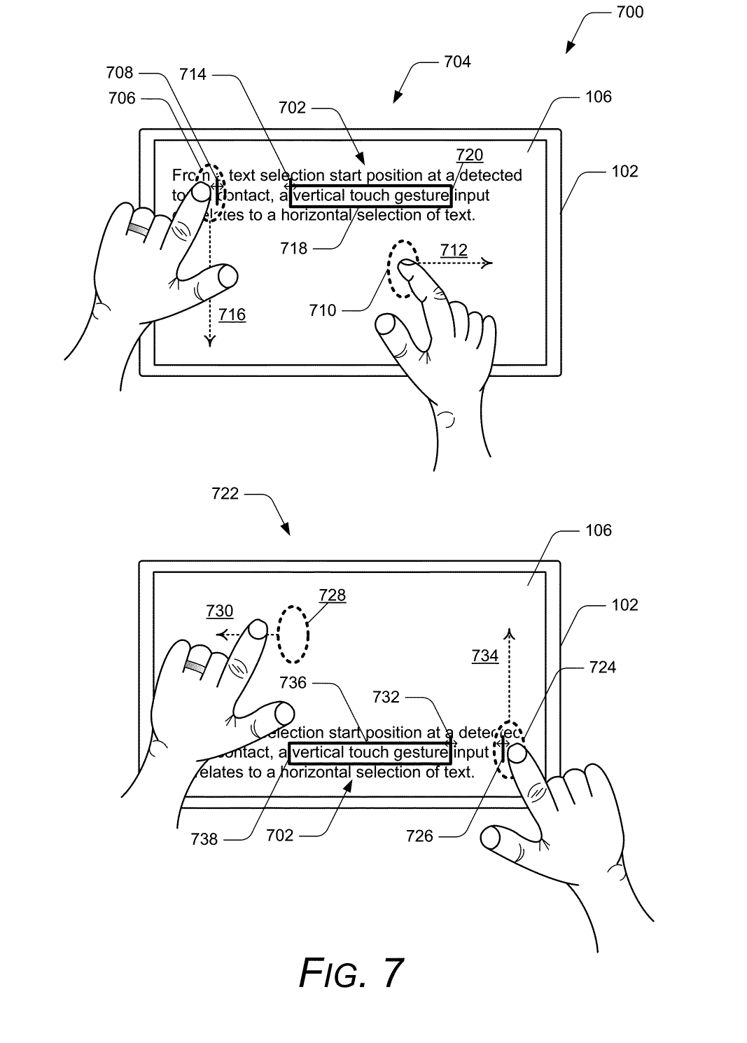

FIG. 7 illustrates examples 700 of a two-finger gesture text selection, such as implemented with the electronic device 102 and the various components described with reference to FIG. 1. The electronic device 102 includes the touch-sensitive interface 106 as part of an integrated display on which text 702 is displayed. As shown at 704, a user can initiate a touch contact 706 with a first finger on the touch-sensitive interface of the device, and the touch gesture application 110 is implemented to determine an initial text selection start position 708 from the detected touch contact. The user can also initiate an additional touch contact 710 with a second finger at a different position on the touch-sensitive interface, and continue with a first touch gesture input 712 starting from the additional touch contact. The touch gesture application 110 can track the first touch gesture input as a continuation of the detected additional touch contact 710.

The direction of the first touch gesture input 712 moves right and is horizontal relative to the orientation of the device. The direction of the first touch gesture input is also in a direction parallel to the text-line orientation, which is horizontal text in this example. The touch gesture application 110 can track the first touch gesture input 712 and establish a repositioned text selection start position 714 based on the first touch gesture input 712 that is continued from the additional touch contact 710 in the direction parallel to the text-line orientation. In this implementation, the initial text selection start position is repositioned using the second finger, and without the first finger blocking the user's view of the intended text selection start position.

The user can then initiate a second touch gesture input 716 on the touch-sensitive interface with the first finger in a direction orthogonal to the text-line orientation. The touch gesture application 110 can track the second touch gesture input as a continuation of the first touch contact 706. In this example, the direction of the second touch gesture input moves down relative to the orientation of the device. The direction of the second touch gesture input is also orthogonal to the text-line orientation of the text, and the second touch gesture input traverses across lines of the text relative to the text-line orientation. In an embodiment, the touch gesture application 110 is implemented to correlate the second touch gesture input 716 to a selection of text 718 in a direction parallel to the text-line orientation beginning from the repositioned text selection start position 714 and selecting to the right to a text selection end position 720. In this example, the selection of the text is less than an entire line of the text and proportional to a distance of the second touch gesture input 716, such as previously described with respect to FIG. 2.

In the example shown at 722, a user can initiate a touch contact 724 with a first finger on the touch-sensitive interface of the device, and the touch gesture application 110 is implemented to determine an initial text selection start position 726 from the detected touch contact. The user can also initiate an additional touch contact 728 with a second finger at a different position on the touch-sensitive interface, and continue with a first touch gesture input 730 starting from the additional touch contact. The touch gesture application 110 can track the first touch gesture input 730 as a continuation of the detected additional touch contact 728.

The direction of the first touch gesture input 730 moves left and is horizontal relative to the orientation of the device. The direction of the first touch gesture input is also in a direction parallel to the text-line orientation, which is horizontal text in this example. The touch gesture application 110 can track the first touch gesture input 730 and establish a repositioned text selection start position 732 based on the first touch gesture input 730 that is continued from the additional touch contact 728 in the direction parallel to the text-line orientation. In this implementation, the initial text selection start position is repositioned using the second finger, and without the first finger blocking the user's view of the intended text selection start position.

The user can then initiate a second touch gesture input 734 on the touch-sensitive interface with the first finger in a direction orthogonal to the text-line orientation. The touch gesture application 110 can track the second touch gesture input as a continuation of the first touch contact 724. In this example, the direction of the second touch gesture input moves up relative to the orientation of the device. The direction of the second touch gesture input is also orthogonal to the text-line orientation of the text, and the second touch gesture input traverses across lines of the text relative to the text-line orientation. In an embodiment, the touch gesture application 110 is implemented to correlate the second touch gesture input 734 to a selection of text 736 in a direction parallel to the text-line orientation beginning from the repositioned text selection start position 732 and selecting to the left to a text selection end position 738. In this example, the selection of the text is less than an entire line of the text and proportional to a distance of the second touch gesture input 734, such as previously described with respect to FIG. 2.

In the example shown at 704, the selection of text 718 is a section along the line of the text after the repositioned text selection start position 714 (i.e., to the right of the repositioned text selection start position), and the text selection is based on the second touch gesture input 716 traversing down across the lines of the text in the direction orthogonal to the text-line orientation. Alternatively, in the example shown at 722, the selection of text 736 is a section along the line of the text before the repositioned text selection start position 732 (i.e., to the left of the repositioned text selection start position), and the text selection is based on the second touch gesture input 734 traversing up across the lines of the text in the direction orthogonal to the text-line orientation.

A benefit of this variant of gesture text selection shown in the examples 700, where the second finger can be used to reposition the text selection start position, is that the first finger does not have to be removed from the touch-sensitive interface in order to visually verify the intended text selection start position. When the text selection start position is repositioned to a location outside of the first touch contact position, and the repositioned text selection start position is the text selection start position desired by the user, the first finger can then be used to perform the second touch gesture input to select text starting from the desired text selection start position.

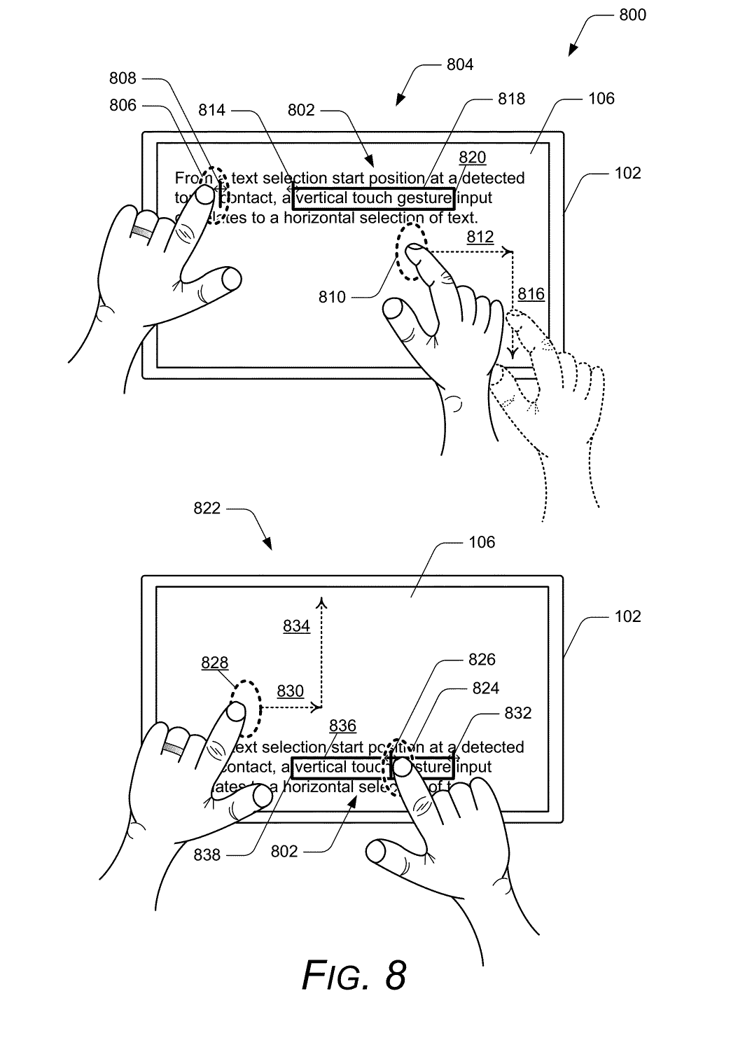

FIG. 8 illustrates examples 800 of two-finger gesture text selection, such as implemented with the electronic device 102 and the various components described with reference to FIG. 1. The electronic device 102 includes the touch-sensitive interface 106 as part of an integrated display on which text 802 is displayed. As shown at 804, a user can initiate a touch contact 806 with a first finger on the touch-sensitive interface of the device, and the touch gesture application 110 is implemented to determine an initial text selection start position 808 from the detected touch contact. The user can then initiate an additional touch contact 810 with a second finger at a different position on the touch-sensitive interface, and continue with a first touch gesture input 812 starting from the additional touch contact.

The touch gesture application 110 can track the first touch gesture input 812 as a continuation of the detected additional touch contact 810. In this example, the direction of the first touch gesture input moves right and is horizontal relative to the orientation of the device. The direction of the first touch gesture input is also in a direction parallel to the text-line orientation, which is horizontal text in this example. In an embodiment, the touch gesture application is implemented to establish a repositioned text selection start position 814 based on a distance of the first touch gesture input 812 relative to the position of the first touch contact 810 in the direction right and parallel to the text-line orientation.

The user can then initiate a second touch gesture input 816 on the touch-sensitive interface in a direction orthogonal to the text-line orientation. The touch gesture application 110 can track the second touch gesture input from the end of the first touch gesture input 812. In this example, the direction of the second touch gesture input moves down relative to the orientation of the device. The direction of the second touch gesture input is also orthogonal to the text-line orientation of the text, and the second touch gesture input traverses across lines of the text relative to the text-line orientation. In an embodiment, the touch gesture application 110 is implemented to correlate the second touch gesture input 816 to a selection of text 818 in a direction parallel to the text-line orientation beginning from the repositioned text selection start position 814 to a text selection end position 820. In this example, the selection of the text is less than an entire line of the text and proportional to a distance of the second touch gesture input 816, such as previously described with respect to FIG. 4.

In the example shown at 822, a user can initiate a touch contact 824 with a first finger on the touch-sensitive interface of the device, and the touch gesture application 110 is implemented to determine an initial text selection start position 826 from the detected touch contact. The user can then initiate an additional touch contact 828 with a second finger at a different position on the touch-sensitive interface, and continue with a first touch gesture input 830 starting from the additional touch contact. The touch gesture application 110 can track the first touch gesture input 830 as a continuation of the detected additional touch contact 828. In this example, the direction of the first touch gesture input moves right and is horizontal relative to the orientation of the device. The direction of the first touch gesture input is also in a direction parallel to the text-line orientation, which is horizontal text in this example. In an embodiment, the touch gesture application is implemented to establish a repositioned text selection start position 832 based on a distance of the first touch gesture input 830 relative to the position of the first touch contact 824 in the direction right and parallel to the text-line orientation.

The user can then initiate a second touch gesture input 834 on the touch-sensitive interface in a direction orthogonal to the text-line orientation. The touch gesture application 110 can track the second touch gesture input from the end of the first touch gesture input 830. In this example, the direction of the second touch gesture input moves up relative to the orientation of the device. The direction of the second touch gesture input is also orthogonal to the text-line orientation of the text, and the second touch gesture input traverses across lines of the text relative to the text-line orientation. In an embodiment, the touch gesture application 110 is implemented to correlate the second touch gesture input 834 to a selection of text 836 in a direction parallel to the text-line orientation beginning from the repositioned text selection start position 832 to a text selection end position 838. In this example, the selection of the text is less than an entire line of the text and proportional to a distance of the second touch gesture input 834, such as previously described with respect to FIG. 4.

In the example shown at 804, the selection of text 818 is a section along the line of the text after the repositioned text selection start position 814 (i.e., to the right of the repositioned text selection start position), and the text selection is based on the second touch gesture input 816 traversing down across the lines of the text in the direction orthogonal to the text-line orientation. Alternatively, in the example shown at 822, the selection of text 836 is a section along the line of the text before the repositioned text selection start position 832 (i.e., to the left of the text selection start position), and the text selection is based on the second touch gesture input 834 traversing up across the lines of the text in the direction orthogonal to the text-line orientation.

A benefit of this variant of two-finger gesture text selection shown in the examples 800 is that the touch-sensitive interface 106 can detect a placement of the second finger while the first finger is still in contact with the touch-sensitive interface. Then, the first finger can be removed from the touch-sensitive interface and the text selection start position can be repositioned using a first touch gesture input with the second finger in a direction parallel to the text-line orientation, and without the first finger blocking the text selection view.

In the previous examples of FIGS. 2-8, only intra-line text 212, 228, 312, 414, 432, 516, 532, 618, 636, 718, 736, 818, 836 has been selected. In practice, embodiments of gesture text selection may also be used to select text from more than one text-line. The selected text may be two partial text-lines with any number of full text-lines in-between, one full text-line and a partial text-line with any number of full text-lines in-between, or multiple full text-lines. The selected text may also extend to a paragraph or multiple paragraphs as selected by the user.

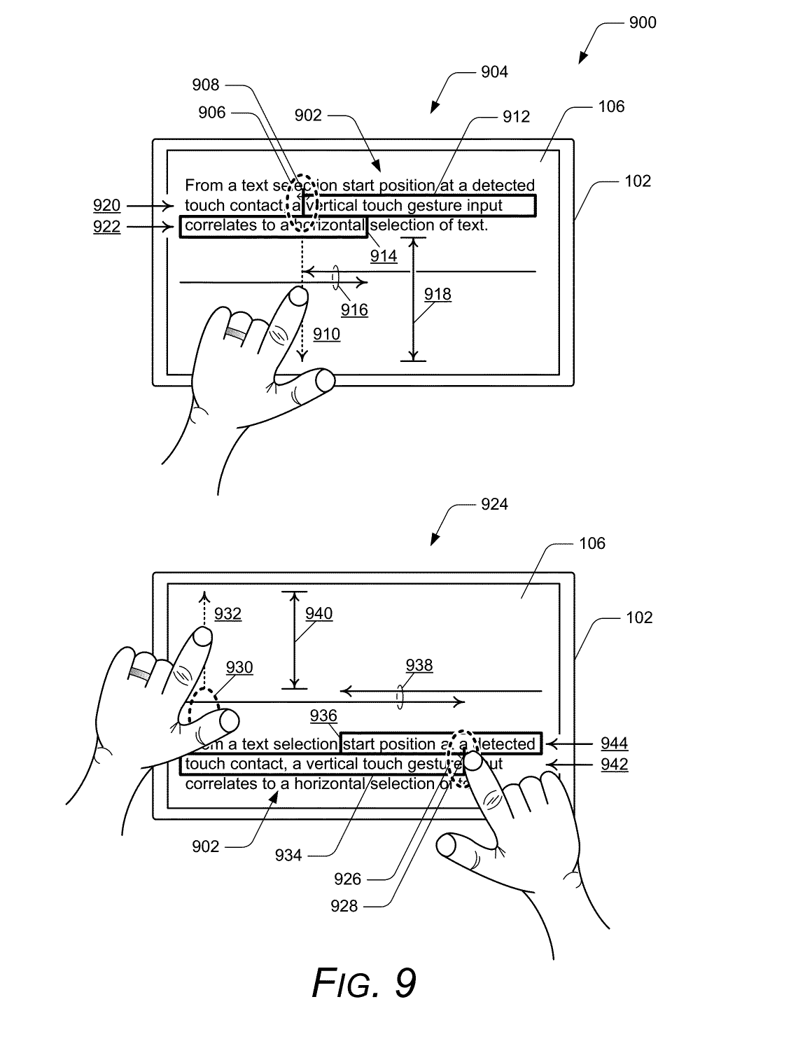

FIG. 9 illustrates examples 900 of gesture text selection that can be used in both one-finger and two-finger implementations for selecting text from multiple text-lines. The gesture text selection examples 900 can be implemented with the electronic device 102 and the various components described with reference to FIG. 1. The gesture text selection examples 900 can also be combined with any of the previously described embodiments. The electronic device 102 includes the touch-sensitive interface 106 as part of an integrated display on which text 902 is displayed. As shown at 904, a user can initiate a touch contact 906 on the touch-sensitive interface of the device, and the touch gesture application 110 can determine a text selection start position 908 from the detected touch contact. The user can initiate a touch gesture input 910 on the touch-sensitive interface starting from the touch contact. The touch gesture application can track the touch gesture input as a continuation of the detected touch contact at the text selection start position. In this example, the direction of the touch gesture input moves down relative to the orientation of the device. The direction of the touch gesture input is also orthogonal to a text-line orientation, which is horizontal text in this example, and the touch gesture input traverses across lines of the text relative to the text-line orientation.

In an embodiment, the touch gesture application 110 is implemented to correlate the touch gesture input 910 to a selection of text 912 in a direction parallel to the text-line orientation beginning from the text selection start position 908 to a text selection end position 914. For example, a length or parallel distance 916 of the text selection is proportional to the orthogonal distance 918 of the touch gesture input 910, where the text selection can be based on a ratio of the parallel distance to the orthogonal distance. In this example, the selection of the text includes a section of a first line 920 of the text as well as a section of a second line 922 of the text. Alternatively or in addition, a selection of the text based on the touch gesture input can include an entire line of the text and part of an additional line of the text and/or more than a single line of the text, such as lines of the text, one or more paragraphs or pages, and sections of the text.

In the example shown at 924, a user can initiate a touch contact 926 on the touch-sensitive interface of the device, and the touch gesture application 110 can determine a text selection start position 928 from the detected touch contact. The user can then initiate an additional touch contact 930 with a second finger at a different position on the touch-sensitive interface, and continue with a touch gesture input 932 starting from the additional touch contact. The touch gesture application can track the touch gesture input as a continuation of the detected additional touch contact 930. In this example, the direction of the touch gesture input moves up relative to the orientation of the device. The direction of the touch gesture input is also orthogonal to the text-line orientation, which is horizontal text in this example, and the touch gesture input traverses across lines of the text relative to the text-line orientation.

In an embodiment, the touch gesture application 110 is implemented to correlate the touch gesture input 932 to a selection of text 934 in a direction parallel to the text-line orientation beginning from the text selection start position 928 to a text selection end position 936. For example, a length or parallel distance 938 of the text selection is proportional to the orthogonal distance 940 of the touch gesture input 932, where the text selection can be based on a ratio of the parallel distance to the orthogonal distance. In this example, the selection of the text includes a section of a first line 942 of the text as well as a section of a second line 944 of the text. Alternatively or in addition, a selection of the text based on the touch gesture input can include an entire line of the text and part of an additional line of the text and/or more than a single line of the text, such as lines of the text, one or more paragraphs or pages, and sections of the text.

For any of the embodiments described herein, instead of a constant ratio of orthogonal distance to parallel distance, the ratio may vary in a geometric or logarithmic manner. As an example of a geometrically-varying ratio, for the first centimeter of orthogonal distance traveled, the proportion of the two distances may be a 1:1 ratio (e.g., the parallel distance of text selection is also one centimeter). Then for the second centimeter of orthogonal distance traveled, the proportion of the two distances may be a 2:1 ratio (e.g., the parallel distance of text selection is the previously-selected one centimeter plus an additional two centimeters). Alternately, the user can repeat the orthogonal touch gesture input 210, 226, 310, 412, 430, 514, 530, 616, 634, 716, 734, 816, 834, 910, 932 to initiate continuing text selection.

When the text selection reaches an extreme of a text-line, the touch gesture application continues the text selection on an adjacent line in a wrap-around manner. If an orthogonal touch gesture input is in the inter-line reading direction (e.g., down for English text) and text selection reaches an end of a text-line, then the text at the beginning of the next line will start to be selected. If the orthogonal touch gesture is against the inter-line reading direction (e.g., up for English text) and text selection reaches a beginning of a text-line, then the text at the end of the prior line will start to be selected.

Additionally, a user can reverse the text selection and/or adjust a text selection end position by simply reversing the orthogonal touch gesture input. In the examples 900, a user can reverse the orthogonal touch gesture input 910 to adjust the text selection end position 914 (i.e., the text selection moves back to the left and then up to a previous text-line). The user can also reverse the orthogonal touch gesture input 932 to adjust the text selection end position 936 (i.e., the text selection moves back to the right and then down to a next text-line). Similarly, a user can reverse the orthogonal touch gesture input 210, 226, 310, 412, 430, 514, 530, 616, 634, 716, 734, 816, 834 to adjust the respective text selection end position 214, 230, 314, 416, 434, 518, 534, 620, 638, 720, 738, 820, 838.

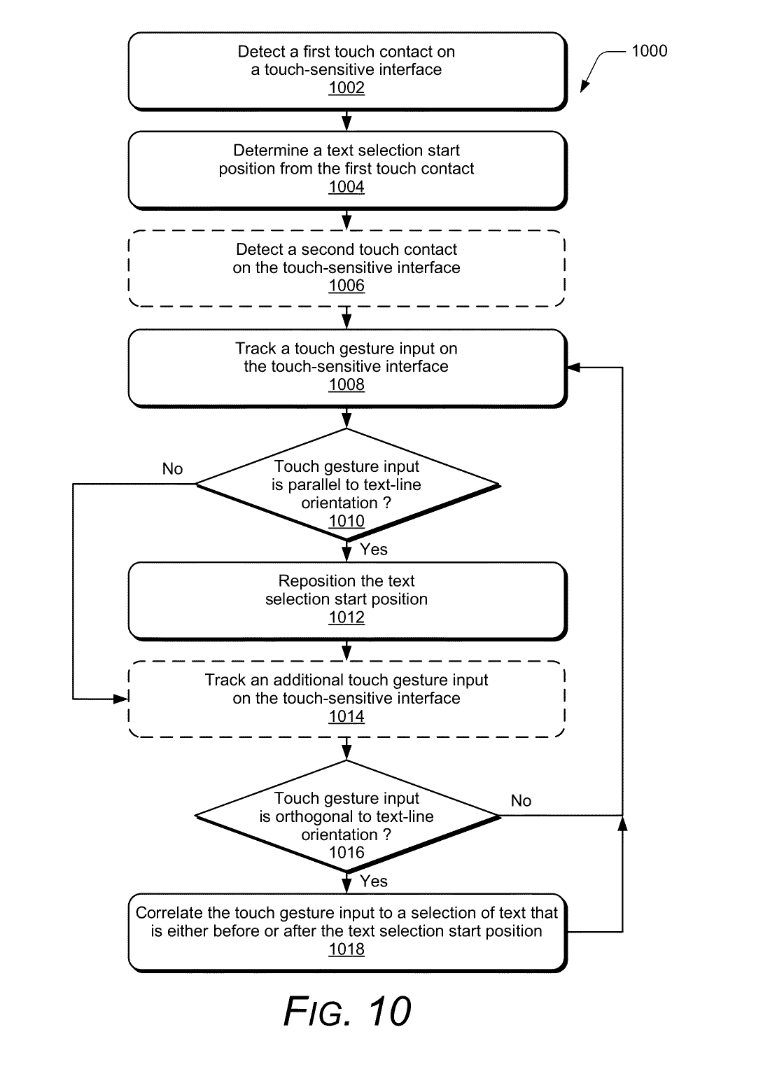

Example method 1000 is described with reference to FIG. 10 in accordance with one or more embodiments of gesture text selection. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 10 illustrates example method(s) 1000 of one-finger (or stylus) or two-finger gesture text selection. The order in which the method blocks are described are not intended to be construed as a limitation, and any number or combination of the described method blocks can be combined in any order to implement a method, or an alternate method.

At block 1002, a first touch contact is detected on a touch-sensitive interface. For example, the touch detection system 104 at the electronic device 102 (FIG. 1) detects a first finger touch contact 206, 222, 306, 406, 424, 506, 522, 606, 624, 706, 724, 806, 824, 906, 926 on the touch-sensitive interface 106 of the device.

At block 1004, a text selection start position is determined from the first touch contact. For example, the touch gesture application 110 at the electronic device 102 determines the text selection start position 208, 224, 308, 408, 426, the initial text selection start position 510, 526, 608, 626, 708, 726, 808, 826, and the text selection start position 908, 928 from the respective detected first touch contacts (i.e., as detected at block 1002).

At optional block 1006, a second touch contact is detected anywhere else on the touch-sensitive interface. For example, the touch detection system 104 at the electronic device 102 detects the second finger touch contact 410, 428, 614, 632, 710, 728, 810, 828, 930 on the touch-sensitive interface 106 of the device.

At block 1008, a touch gesture input is tracked on the touch-sensitive interface. For example, the touch gesture application 110 at the electronic device 102 tracks a touch gesture input that is a continuation of either the first or second detected touch contact on the touch-sensitive interface 106 of the device, such as the touch gesture input 210, 226, 310, 508, 524, 610, 628, 716, 734, 910 that is tracked from a first touch contact, or the touch gesture input 412, 430, 616, 634, 712, 730, 812, 830, 932 that is tracked from a second touch contact.

At decision block 1010, a determination is made as to whether the touch gesture input is tracked in a direction parallel to a text-line orientation. If the touch gesture input is in a direction parallel to the text-line orientation (i.e., “yes” from block 1010), then at block 1012, the text selection start position is repositioned. For example, the touch gesture application 110 at the electronic device 102 tracks the touch gesture input on the touch-sensitive interface 106 in a direction parallel to the text-line orientation of the text, and repositions the initial text selection start position to a repositioned text selection start position based on the touch gesture input.

In the examples described herein, the touch gesture input 508 is in the direction parallel to the text-line orientation of the text and the touch gesture input repositions the initial text selection start position 510 at the touch contact 506 to the repositioned text selection start position 512. Similarly, the touch gesture input 524 repositions the initial text selection start position 526 at the touch contact 522 to the repositioned text selection start position 528. The touch gesture input 610 is in the direction parallel to the text-line orientation of the text and the touch gesture input repositions the initial text selection start position 608 at the touch contact 606 to the repositioned text selection start position 612. Similarly, the touch gesture input 628 repositions the initial text selection start position 626 at the touch contact 624 to the repositioned text selection start position 630.

The touch gesture input 712 is in the direction parallel to the text-line orientation of the text and the touch gesture input repositions the initial text selection start position 708 at the touch contact 706 to the repositioned text selection start position 714. Similarly, the touch gesture input 730 repositions the initial text selection start position 726 at the touch contact 724 to the repositioned text selection start position 732. The touch gesture input 812 is in a direction parallel to the text-line orientation of the text, and the touch gesture input repositions the initial text selection start position 808 at the touch contact 806 to the repositioned text selection start position 814. Similarly, the touch gesture input 830 repositions the initial text selection start position 826 at the touch contact 824 to the repositioned text selection start position 832. As can be observed from these examples, the intra-line touch gesture direction indicates the direction in which the repositioned text selection start position moves.

Continuing from block 1012, or if the touch gesture input is not in a direction parallel to the text-line orientation (i.e., “no” from block 1010), then at optional block 1014, an additional touch gesture input is tracked on the touch-sensitive interface. For example, the touch gesture application 110 at the electronic device 102 tracks a second touch gesture input that is a continuation of either the first touch gesture input or a detected touch contact on the touch-sensitive interface 106 of the device, such as the second touch gesture input 514, 530, 816, 834 that is tracked as a continuation from the first touch gesture input, or the second touch gesture input 616, 634, 716, 734 that is tracked as a continuation from a detected touch contact. In implementations, the second touch gesture input is tracked as a continuation of the first touch gesture input when the second touch gesture input is tracked within a designated duration of time after the first touch gesture input.

At decision block 1016, a determination is made as to whether the touch gesture input (e.g., the first or second touch gesture input) is tracked in a direction orthogonal to a text-line orientation. If the touch gesture input is not in a direction orthogonal to the text-line orientation (i.e., “no” from block 1016), then the method continues at block 1008 to track another touch gesture input on the touch-sensitive interface. Note that the user may continue to adjust a text selection start position with continued parallel touch input gestures, and can oscillate right-and-left to select the desired text selection start position. If the touch gesture input (e.g., the first or second touch gesture input) is in a direction orthogonal to the text-line orientation (i.e., “yes” from block 1016), then at block 1018, the touch gesture input is correlated to a selection of text that is either before or after the text selection start position (e.g., an initial text selection start position or a repositioned text selection start position). A selection of the text can be proportional to a distance of the touch gesture input, and the text selection can be less than an entire line of the text, include an entire line of the text and part of an additional line of the text, or include more than a single line of the text.

In the examples described herein, the touch gesture input 210 is in the direction orthogonal to the text-line orientation of the text in the inter-line reading direction and the touch gesture input correlates to the selection of text 212 after the text selection start position 208 which is in the intra-line reading direction. Similarly, the touch gesture input 226 against the inter-line reading direction correlates to the selection of text 228 before the text selection start position 224 which is against the intra-line reading direction. The touch gesture input 310 is in the inter-line reading direction orthogonal to the text-line orientation of the text and the touch gesture input correlates to the selection of text 312 after the text selection start position 308. The touch gesture input 412 is in the inter-line reading direction orthogonal to the text-line orientation of the text and the touch gesture input correlates to the selection of text 414 after the text selection start position 408. Similarly, the touch gesture input 430 against the inter-line reading direction correlates to the selection of text 432 before the text selection start position 426 which is against the intra-line reading direction. The touch gesture input 910 is in the inter-line reading direction orthogonal to the text-line orientation of the text and the touch gesture input correlates to the selection of text 912 after the text selection start position 908. Similarly, the touch gesture input 932 against the inter-line reading direction correlates to the selection of text 934 before the text selection start position 928.

The touch gesture input 514 is in the inter-line reading direction orthogonal to the text-line orientation of the text and the touch gesture input correlates to the selection of text 516 after the repositioned text selection start position 512. Similarly, the touch gesture input 530 against the inter-line reading direction correlates to the selection of text 532 before the repositioned text selection start position 528. The touch gesture input 616 is in the inter-line reading direction orthogonal to the text-line orientation of the text and the touch gesture input correlates to the selection of text 618 after the repositioned text selection start position 612. Similarly, the touch gesture input 634 against the inter-line reading direction correlates to the selection of text 636 before the repositioned text selection start position 630. The touch gesture input 716 is in the inter-line reading direction orthogonal to the text-line orientation of the text and the touch gesture input correlates to the selection of text 718 after the repositioned text selection start position 714. Similarly, the touch gesture input 734 against the inter-line reading direction correlates to the selection of text 736 before the repositioned text selection start position 732. The touch gesture input 816 is in the inter-line reading direction orthogonal to the text-line orientation of the text and the touch gesture input correlates to the selection of text 818 after the repositioned text selection start position 814. Similarly, the touch gesture input 834 against the inter-line reading direction correlates to the selection of text 836 before the repositioned text selection start position 832.

The method can then continue at block 1008 to track another touch gesture input on the touch-sensitive interface of the electronic device. For example, a user can initiate another orthogonal touch gesture input (e.g., up or down relative to the orientation of the device) after a first orthogonal touch gesture input to oscillate up-and-down to select the desired text selection end position, such as 214, 230, 314, 416, 434, 518, 534, 620, 638, 720, 738, 820, 838, 914, 936. Alternatively, the method can continue from block 1018 to initiate various text selection features that may also be implemented based on the different functions and features of other applications that are implemented by the electronic device. For example, text can be selected for copy and paste, to delete, format, move, and the like with various combinations of detected touch contacts and tracked touch gesture inputs in word processing, database, and spreadsheet applications, as well as in email and other messaging applications, and when browsing websites.

FIG. 11 illustrates various components of an example electronic device 1100 that can be implemented as any device described with reference to any of the previous FIGS. 1-10. The electronic device may be implemented as any one or combination of a fixed or mobile device, in any form of a consumer, computer, portable, user, communication, phone, navigation, gaming, media playback, and/or other type of electronic device.

The electronic device 1100 includes communication transceivers 1102 that enable wired and/or wireless communication of device data 1104, such as received data, data that is being received, data scheduled for broadcast, data packets of the data, etc. Example transceivers include wireless personal area network (WPAN) radios compliant with various IEEE 802.15 (sometimes referred to as Bluetooth™) standards, wireless local area network (WLAN) radios compliant with any of the various IEEE 802.11 (sometimes referred to as WiFi™) standards, wireless wide area network (WWAN) radios for cellular telephony, wireless metropolitan area network (WMAN) radios compliant with various IEEE 802.16 (sometimes referred to as WiMAX™) standards, and wired local area network (LAN) Ethernet transceivers.

The electronic device 1100 may also include one or more data input ports 1106 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as keyboards, microphones, or cameras.

The electronic device 1100 includes one or more processors 1108 (e.g., any of microprocessors, controllers, and the like), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 1110. The electronic device also includes a touch detection system 1112 that is implemented to detect and/or sense touch contacts, such as when initiated by a user as a touch input (touch contact or touch gesture) on a touch-sensitive interface integrated with the device. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 1100 also includes one or more memory devices 1114 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 1100 may also include a mass storage media device.

A memory device 1114 provides data storage mechanisms to store the device data 1104, other types of information and/or data, and various device applications 1116 (e.g., software applications). For example, an operating system 1118 can be maintained as software instructions within a memory device and executed on the processors 1108. The device applications may also include a device manager, such as any form of a control application, software application, signal-processing and control module, code that is native to a particular device, a hardware abstraction layer for a particular device, and so on. In embodiments, the electronic device also includes a touch gesture application 1120 to implement gesture text selection.

The electronic device 1100 also includes an audio and/or video processing system 1122 that generates audio data for an audio system 1124 and/or generates display data for a display system 1126. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1128. In implementations, the audio system and/or the display system are external components to the electronic device. Alternatively, the audio system and/or the display system are integrated components of the example electronic device, such as an integrated touch gesture interface.

As described above, the relationship between the direction of a touch gesture input and the direction of a corresponding text selection may be counter-intuitive. However, the selected text in a horizontal, parallel direction is not blocked from view by a hand or finger when a user initiates a touch gesture input in a vertical, orthogonal direction. Additionally, embodiments of gesture text selection can be implemented for written languages other than the English language, such as for Chinese, Hebrew, or Arabic, where the other languages are written in different directions other than from left-to-right and read from top-to-bottom as with standard English text. Although embodiments of gesture text selection have been described in language specific to features and/or methods, the subject of the appended claims is not necessarily limited to the specific features or methods described. Rather, the specific features and methods are disclosed as example implementations of gesture text selection.

1. A method, comprising:
determining an initial text selection start position from a detected touch contact on a touch-sensitive interface;
tracking a first touch gesture input on the touch-sensitive interface in a direction parallel to a text-line orientation to reposition the initial text selection start position to a repositioned text selection start position;
tracking a second touch gesture input on the touch-sensitive interface in a direction orthogonal to the text-line orientation; and
correlating the second touch gesture input to a selection of text beginning from the repositioned text selection start position and continuing parallel to the text-line orientation.

2. A method as recited in claim 1, wherein the selection of text is proportional to a distance of the second touch gesture input.

3. A method as recited in claim 1, further comprising:
determining that the second touch gesture input traverses across lines of text relative to the text-line orientation for one of:
selecting a section of text that appears along a line of text after the repositioned text selection start position; or
selecting a section of text that appears along the line of text before the repositioned text selection start position.

4. A method as recited in claim 1, further comprising:
detecting the second touch gesture input on the touch-sensitive interface as a continuation of the first touch gesture input, when the second touch gesture input is tracked within a designated duration of time after the first touch gesture input.

5. A method as recited in claim 1, further comprising:
selecting a section of text that traverses two or more lines of text.

6. A method as recited in claim 1, wherein the second touch gesture input is tracked on the touch-sensitive interface as a continuation of the first touch gesture input.

7. A method as recited in claim 1, wherein the second touch gesture input is tracked on the touch-sensitive interface as a continuation of a second detected touch contact.

8. A method, comprising:
initializing a text selection feature based on a detected touch contact on a touch-sensitive interface;
tracking a first touch gesture input in a direction parallel to a text-line orientation in order to determine a text selection start position;
tracking a second touch gesture input in a direction orthogonal to the text-line orientation; and
correlating the second touch gesture input to a selection of text in a direction parallel to the text-line orientation beginning from the text selection start position, the selection of text proportional to a distance of the second touch gesture input.

9. A method as recited in claim 8, wherein the selection of text is based on a ratio of a parallel distance to the distance of the second touch gesture input in the direction orthogonal to the text-line orientation.

10. A method as recited in claim 8, further comprising one of:
determining that the first touch gesture input repositions the text selection start position at text that appears before the detected touch contact; or
determining that the first touch gesture input repositions the text selection start position at text that appears after the detected touch contact.

11. A method as recited in claim 8, further comprising:
determining that the second touch gesture input traverses across lines of text relative to the text-line orientation for one of:
selecting a section of text that appears along a line of text after the text selection start position; or
selecting the section of text that appears along the line of text before the text selection start position.

12. A method as recited in claim 8, further comprising:
selecting a section of text that traverses two or more lines of text.

13. A method as recited in claim 8, wherein:
the first touch gesture input is tracked on the touch-sensitive interface as a continuation of the detected touch contact; and
the second touch gesture input is tracked on the touch-sensitive interface as a continuation of the first touch gesture input.

14. A method as recited in claim 8, wherein:
the first touch gesture input is tracked on the touch-sensitive interface starting from an additional detected touch contact anywhere on the touch-sensitive interface; and
the second touch gesture input is tracked on the touch-sensitive interface as a continuation of the first touch gesture input.

15. An electronic device, comprising:
a touch detection system configured to detect a touch contact and a touch gesture input on a touch-sensitive interface, the touch gesture input being orthogonal to a text-line orientation;
at least a memory and a processor to execute a touch gesture application that is configured to:
determine a text selection start position from the touch contact; and
correlate the touch gesture input to a selection of text in a direction parallel to the text-line orientation beginning from the text selection start position, the selection of text less than an entire line of text and proportional to a distance of the touch gesture input.

16. The electronic device as recited in claim 15, wherein the touch gesture application is further configured to one of:
select a section of text that appears along a line of text before the text selection start position based on the touch gesture input traversing across lines of text in a first direction orthogonal to the text-line orientation; or
select the section of text that appears along the line of text after the text selection start position based on the touch gesture input traversing across the lines of text in a second direction orthogonal to the text-line orientation.

17. The electronic device as recited in claim 15, wherein the touch gesture application is further configured to track the touch gesture input on the touch-sensitive interface as a continuation of the touch contact.

18. The electronic device as recited in claim 15, wherein:
the touch detection system is further configured to detect an additional touch contact on the touch-sensitive interface; and
the touch gesture application is further configured to track the touch gesture input on the touch-sensitive interface starting from the additional touch contact.

19. The electronic device as recited in claim 15, wherein:
the touch detection system is further configured to detect an additional touch gesture input on the touch-sensitive interface, the additional touch gesture input being parallel to the text-line orientation;
the touch gesture application is further configured to reposition the text selection start position from the touch contact and the additional touch gesture input, where the additional touch gesture input one of:
establishes a repositioned text selection start position at text that appears before the touch contact; or
establishes the repositioned text selection start position at text that appears after the touch contact.

20. The electronic device as recited in claim 19, wherein:
the touch detection system is further configured to detect an additional touch contact on the touch-sensitive interface;
the touch gesture application is further configured to:
track the additional touch gesture input on the touch-sensitive interface starting from the additional touch contact; and
track the touch gesture input on the touch-sensitive interface as a continuation of the additional touch gesture input.
